(19) United States
(12) Patent Application Publication
(10) Pub. No.: US 2009/0254800 A1
(43) Pub. Date: Oct. 8, 2009

(54) METHOD FOR PROVIDING USER-DEFINITIONS OF TERMS

(75) Inventors: Joseph K. Chacko, Sheffield (GB); Kevin Marsh, Eastleigh (GB); Hedley Proctor, Southampton (GB); Ian Burnett, Southampton (GB)

Correspondence Address: IBM CORPORATION (ACCSP);c/o Suiter Swantz pc llo, 14301 FNB Parkway, Suite 220, Omaha, NE, 68154, US

(73) Assignee: INTERNATIONAL BUSINESS MACHINES CORPORATION, Armonk, NY (US)

(21) Appl. No.: 12/098,974

(22) Filed: Apr. 7, 2008

(51) Int. Cl. G06F 17/21

(52) U.S. Cl. 715/205

(57) ABSTRACT

The present disclosure is a method for providing user-definitions of terms associated with a document. A method for providing user-definitions of terms may include providing a document, receiving text, receiving a request to define a term within the document, associating the user-provided definition of the term with the document, notifying the term includes the user-provided definition, receiving a request to view the user-provided definition, and displaying the definition to the remote user.

### TECHNICAL FIELD

The present invention generally relates to the field of word processing, and more particularly to a method for providing user-definitions of terms.

### BACKGROUND

Terms are often used by one person with a certain intended meaning. In many instances, a meaning of a term is specific to a project and well-known by many people associated with the project. Miscommunication and misunderstanding may result if one party has a different meaning of a term than a meaning understood by another party.

Disambiguation of terms is usually achieved through manual intervention. For example, consider a conversation in which one of the participants uses an acronym that has a different meaning to the other participant. This is a simple error that could be detected early and corrected easily.

In a more complex conversation, several factors may combine to make misunderstanding more likely and more difficult to resolve. For instance, there may be embarrassment in admitting a lack of understanding, there may be no clear mismatch in concepts, or there may be a lack of time during the exchange to notice and to deal with all unknown or mismatched terms.

### SUMMARY

The present disclosure is directed to a method for providing user-definitions of terms associated with a document. In an embodiment, method for providing user-definitions of terms may include providing a document, receiving text, receiving a request to define a term within the document, receiving a user-definition for a term from a user, associating the user-provided definition of the term with the document, notifying the term includes the user-provided definition, receiving a request to view the user-provided definition, and displaying the definition to the remote user.

It is to be understood that both the foregoing general description and the following detailed description are exemplary and explanatory only and are not necessarily restrictive of the present disclosure. The accompanying drawings, which are incorporated in and constitute a part of the specification, illustrate subject matter of the disclosure. Together, the descriptions and the drawings serve to explain the principles of the disclosure.

### BRIEF DESCRIPTION OF THE DRAWINGS

The numerous advantages of the disclosure may be better understood by those skilled in the art by reference to the accompanying figures in which:

FIG. 1 is a flow diagram illustrating a method for providing user-definitions of terms.

### DETAILED DESCRIPTION

Reference will now be made in detail to the subject matter disclosed, which is illustrated in the accompanying drawings.

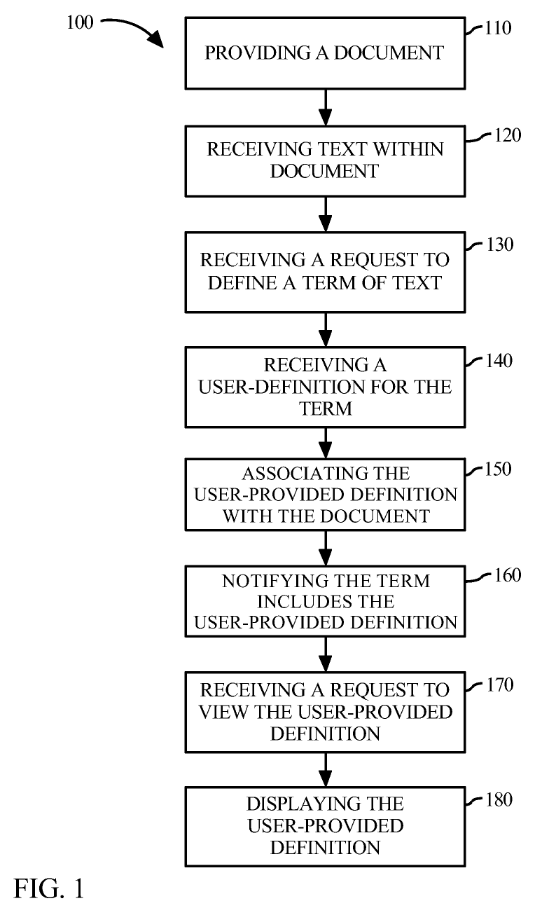

Referring to FIG. 1, a flow diagram illustrating a method for providing user-definitions of terms is shown. Method 100 for providing user definitions of terms may begin by providing a document 110. A document may refer to any type of mechanism for receiving a written text, including an electronic mail message, instant message, word processing document, web page and the like. Method 100 may include receiving text 120, such as a plurality of terms. Method 100 may include receiving a request to define a term within the document 130. Method 100 may include receiving a user-definition for a term from a user 140. Method 100 may include associating the user-provided definition of the term with the document 150. Another step of method 100 may include notifying the term includes the user-provided definition 160. After receiving a request to view the user-provided definition 170, method 100 may include displaying the definition 180.

It is contemplated that method 100 may be executed by a word processing application of a computing appliance. For example, word processing application may include word processing software associated with a personal computer. Word processing application may also be an electronic mail application, instant messaging application, web page design application and the like. Computing appliance may include a personal computer, server, cellular phone, personal digital assistant and the like.

Advantageously, terms which have been selected by a user to include a definition may be associated with the document, such as an instant message. Thus a remote user, receiving an instant message, may also access the associated definition supplied by the user in the creation of the instant message. It is contemplated that a defined word may include an alert, or notification, which signifies that the term has an associated user-definition. For example, the word may be displayed with a visual marker, such as a different font, a different color, underlined, highlighted and other means for distinguishing the term from the rest of the text of the document.

When a document is being produced, it is contemplated that when a user enters a word, word processing application may allow the user to select the word and provide a definition for the word. A remote user, who receives a document with user-definitions of terms, may be capable of accessing a user-definition of a term associated with the document. If an entered word is not already defined or listed in a spelling wordlist, and matches some optional pattern (e.g. all capitals), it may be flagged as a term requiring definition.

Known terms may be displayed as hyperlinks, much as many IM clients now display URLs and e-mail addresses. Terms matching some pattern (e.g. CamelCase or TLAs) may be given a “?” link at the end, to prompt for a definition by any participant.

It is contemplated that user-definitions may be downloaded automatically (according to a remote user's preferences) for later viewing or only when the hyperlink is followed. If the remote user follows the presented hyperlink (e.g. clicking or hovering), the definition may be displayed by the word processing application and an option to adopt the definition may be presented.

If a single term has distinct definitions in the dictionaries of the remote and local users, a word processing application may highlight the clash of terms to notify users. Both definitions may be presented to the remote user, and one of two alternatives may be provided to users. If the meanings are similar, a user may accede to the received definition, replacing the existing definition, or the user may store the received definition as an alternative expression of the existing definition. If the meanings differ, the user may store the received definition as a secondary alternative to the existing definition, or the user may store the received definition as the primary definition, making the existing definition a secondary alternative

It is contemplated that the user-definition for each term may be stored locally to an instant messaging (IM) client, and propagated in parallel with IM conversations. This allows the definition to follow a term around, no matter how far the use of the term spreads through IM.

Additionally, word processing application may allow a user to maintain a local dictionary of terms. The definition for each term could be an expansion of an acronym, a descriptive paragraph, a URL, a file attachment, or a combination of several of these. As a result, theses user-definitions may be copied within a new document without requiring the user to enter each user-definition.

When communicating with a remote user, terms may be presented as hyperlinks to the remote user. Conflicting definitions may be automatically detected and flagged to both users, inviting clarification. Definitions made by one user can be propagated to many users' dictionaries, and the meanings of terms can spread with those terms.

The original creator of a user-definition may also be credited, and referred back to for clarification by, for example, someone translating a definition. Since the origin of a definition may be recorded, updated definitions may be retrieved. Potential misunderstandings are captured early, and clarity of communication is enhanced.

In the present disclosure, the methods disclosed may be implemented as sets of instructions or software readable by a device. Further, it is understood that the specific order or hierarchy of steps in the methods disclosed are examples of exemplary approaches. Based upon design preferences, it is understood that the specific order or hierarchy of steps in the method can be rearranged while remaining within the disclosed subject matter. The accompanying method claims present elements of the various steps in a sample order, and are not necessarily meant to be limited to the specific order or hierarchy presented.

It is believed that the present disclosure and many of its attendant advantages will be understood by the foregoing description, and it will be apparent that various changes may be made in the form, construction and arrangement of the components without departing from the disclosed subject matter or without sacrificing all of its material advantages. The form described is merely explanatory, and it is the intention of the following claims to encompass and include such changes.

What is claimed is:

1. A method for providing user-definitions to terms, comprising:
providing a document, wherein said document is at least one of an instant message or electronic mail message;
receiving text within said document;
receiving a request to define a term of said text within said document;
receiving a user-provided definition of the term of said text from a user, an identity of said user being provided with said user-provided definition of the term;
associating the user-provided definition of the term of said text with said document, said associating the user-provided definition includes providing a link to said user-provided definition, said associating the user-provided definition includes transferring said user-provided definition with said document;
notifying the term includes the user-provided definition, said notifying the term includes the user-provided definition includes providing a visual marker for said term;
receiving a request to view the user-provided definition; and
displaying the user-provided definition;
receiving a second request to define the term of said text within said document;
receiving a second user-provided definition of the term of said text from a second user, an identity of said second user being provided with said second user-provided definition of the term;
associating the second user-provided definition of the term of said text with said document;
receiving a second request to view the user-provided definition and the second user provided definition; and
displaying the user-provided definition and the second user-provided definition.
